(19) United States
(12) Patent Application Publication
(10) Pub. No.: US 2015/0341541 A1
(43) Pub. Date: Nov. 26, 2015

(54) METHODS AND SYSTEMS OF REMOTE ACQUISITION OF DIGITAL IMAGES OR MODELS

(71) Applicant: TIKESWAR NAIK, sunnyvale, CA (US)

(72) Inventor: TIKESWAR NAIK, sunnyvale, CA (US)

(21) Appl. No.: 14/592,347

(22) Filed: Jan. 8, 2015

Related U.S. Application Data
(60) Provisional application No. 62/002,577, filed on May 23, 2014.
(60) Provisional application No. 62/047,630, filed on Sep. 8, 2014.

(51) Int. Cl. H04N 5/232; H04M 1/02; H04N 7/18

(52) U.S. Cl. CPC H04N 5/23206; H04N 7/181; H04M 1/0264

(57) ABSTRACT

In one embodiment, a method includes receiving a digital-image request. The digital-image request includes a digital-image content instruction and a digital-image content location instruction. The digital-image request is generated by a first user. A digital camera of a second user at a location designated in the digital-image content location instruction is determined. The digital camera is integrated into a second user's mobile device. A step includes communicating the digital-image request to the second user's mobile device. A digital image is received from the second user's mobile device. The digital image is communicated to a first user's computing device.

### CROSS-REFERENCE TO RELATED APPLICATIONS

This application is a continuation-in-part of and claims priority to U.S. provisional patent application No. 62/002,577, titled METHODS AND SYSTEMS OF REMOTE DIGITAL ACQUISITION AND/OR OTHER SERVICES, filed on 23 May 2014. This provisional patent application is incorporated herein by reference.

This application is a continuation-in-part of and claims priority to U.S. provisional patent application No. 62/047,630, titled METHODS AND SYSTEMS OF REMOTE DIGITAL ACQUISITION AND/OR OTHER SERVICES, filed on 8 Sep. 2014. This provisional patent application is incorporated herein by reference.

### BACKGROUND

1. Field

This application relates generally to digital image acquisition, and more specifically to a system, article of manufacture and method of remote acquisition of digital images and/or models.

2. Related Art

Digital cameras have proliferated. At the same time, the Internet and other computerized communication networks enable substantially instantaneous communication between people around the globe. For example, a person in India can communicate with a person in Canada with a mobile device and a computer network. Accordingly, improvements to remote acquisition of digital images from remote digital cameras can utilize these recent technological trends.

### BRIEF SUMMARY OF THE INVENTION

In one aspect, a method includes receiving a digital-image request. The digital-image request includes a digital-image content instruction and a digital-image content location instruction. The digital-image request is generated by a first user. A digital camera of a second user at a location designated in the digital-image content location instruction is determined. The digital camera is integrated into a second user's mobile device. A step includes communicating the digital-image request to the second user's mobile device. A digital image is received from the second user's mobile device. The digital image is communicated to a first user's computing device.

In another aspect, a method includes receiving a digital-image request. The digital-image request includes a digital-image content instruction and a digital-image content location instruction. The digital-image request is generated by a first user. A set of digital cameras of a plurality of other users at a location designated in the digital-image content location instruction is determined. The set of digital cameras is integrated into a plurality of other users' mobile devices. The digital-image request is communicated to the plurality of other users' mobile devices. A set of digital images is received from one or more of the plurality of other users' mobile devices. The set of digital images is communicated to a first user's computing device.

### BRIEF DESCRIPTION OF THE DRAWINGS

FIG. 1 illustrates an example method for retrieving digital images from a remote source based on one or more context attributes, according to some embodiments.

FIG. 2 illustrates an example process of e-commerce of remote digital image and/or model acquisition according to some embodiments.

FIG. 3 illustrates another example process of e-commerce of remote digital image and/or model acquisition according to some embodiments, according to some embodiments.

FIG. 4 is a block diagram of a sample computing environment that can be utilized to implement various embodiments.

FIG. 5 depicts computing system with a number of components that may be used to perform any of the processes described herein.

FIG. 6 depicts, in block diagram format, an example remote Third-party digital acquisition service server entity, according to some embodiments.

FIG. 7 depicts, in block diagram format, an example system for implementing a third-party digital acquisition service, according to some embodiments.

The Figures described above are a representative set, and are not an exhaustive with respect to embodying the invention.

### DESCRIPTION

Disclosed are a system, method, and article of manufacture of remote acquisition of digital images and/or models (e.g. models used to 3D printing) and/or other services. The following description is presented to enable a person of ordinary skill in the art to make and use the various embodiments. Descriptions of specific devices, techniques, and applications are provided only as examples. Various modifications to the examples described herein can be readily apparent to those of ordinary skill in the art, and the general principles defined herein may be applied to other examples and applications without departing from the spirit and scope of the various embodiments.

Reference throughout this specification to “one embodiment,” “an embodiment,” ‘example,’ or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

As used herein in, use of terms such as ‘current’, ‘real time’ and/or other similar synonyms assume various latencies such as networking and/or processing latencies.

### DEFINITIONS

3D printing marketplace is a virtual space (website) where users buy, sell and freely share digital 3D printable files for use on 3D printers.

3D modeling can be the process of developing a mathematical representation of any three-dimensional surface of object (either inanimate or living) via specialized software.

Context awareness can refer to the idea that computers can both sense, and react based on their environment.

Digital camera can be a camera that encodes digital images and videos digitally and stores them for later reproduction. In various embodiments, the digital camera can be a standalone camera, part of a mobile device like smart phone or tablet, part of a wearable like Google Glass® or smart watch, part of a drone device, GoPro®, part of a per-installed camera like a security or special view camera, etc. Also the system's ability to coordinate with multiple types of these devices at the same time to accomplish a task.

Image can be a digital image file and/or digital video file.

Mobile device can include a handheld computing device that includes an operating system (OS), and can run various types of application software, known as apps. Example handheld devices can also be equipped with various context sensors (e.g. biosensors, physical environmental sensors, etc.), digital cameras, Wi-Fi, Bluetooth, and/or GPS capabilities. Mobile devices can allow connections to the Internet and/or other Bluetooth-capable devices, such as an automobile, a wearable computing system and/or a microphone headset. Exemplary mobile devices can include smart phones, tablet computers, optical head-mounted display (OHMD) (e.g. Google Glass®), virtual reality head-mounted display, smart watches, other wearable computing systems, etc.

Online social network service is a platform to build social networks or social relations among people who, for example, share interests, activities, backgrounds or real-life connections. A social network service can consists of a representation of each user (e.g. a profile, an avatar, etc.), his/her social links, and a variety of additional services. Social networking can include web-based services that allow individuals to create a public profile, to create a list of users with whom to share connection, and view and cross the connections within the system.

Exemplary Methods

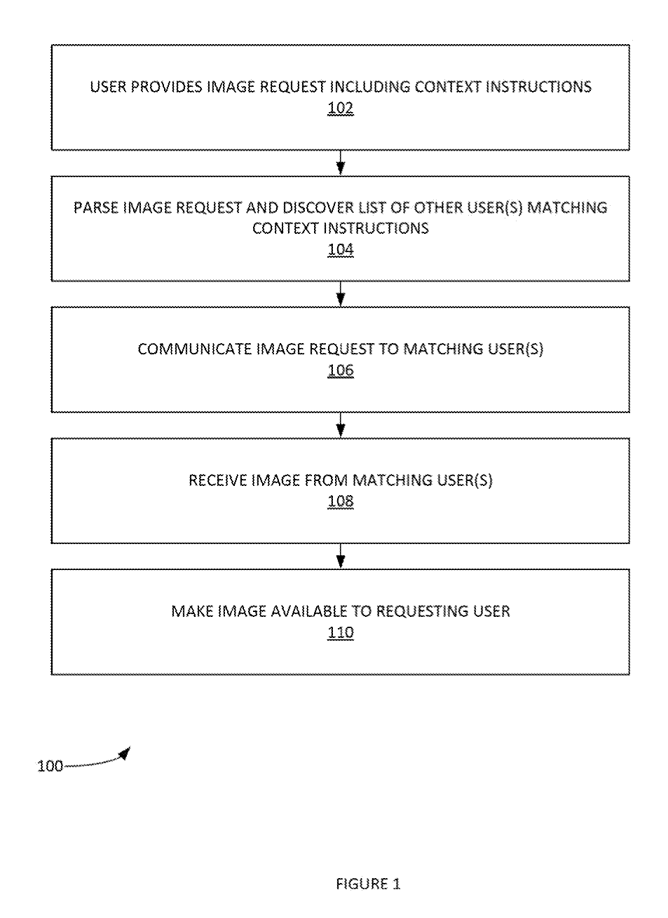

FIG. 1 illustrates an example method 100 for retrieving digital images from a remote source based on one or more context attributes, according to some embodiments. As used herein, a context attribute can include various environmental attributes (e.g. weather, time of day), location attributes (e.g. a geographic location, an architectural location, a transportation route location, etc.), user attributes (e.g. heart rate, breath rates, current activities, language attributes, demographic attributes, etc.), political entity attributes (e.g. nation, state, county, cities, etc.), camera attributes (e.g. exposure times, distances, focal lengths, color settings, filters, lens selection, etc.). In step 102, a user can provide an image request to an image acquisition system with one or more context instructions. The context instructions can include a list of one or more context attributes. For example, a user can request an image of the Taj Mahal at a specified time of the day and specified photographic filters. The user's mobile device that includes an application configured to receive the request and communicate it to a server functionality of the image acquisition system.

In step 104, the request can be parsed (e.g. identify various separate context attributes of the context instructions). A list of other user(s) who match the context instructions can be generated. For example, each user's mobile device application can periodically acquire the user's current context attributes (e.g. current location, environmental attributes via sensors and/or queries to servers with information about environmental attributes, etc.). As used herein in, use of terms such as ‘current’, ‘real time’ and/or other similar synonyms assume various latencies such as networking and/or processing latencies. In some examples, the other user(s) in the list can be ranked based on such factors as the number of matches of the respective user with the context instructions, user's rating with respect to past image provisions to the image acquisition system, user's mobile device type as appropriate for the task, and the like. A specified subset of matched users can then be selected. It is understood that the matched users need not be in the social circle of the requesting user.

In step 106, an image acquisition request can be communicated to the selected matching users (e.g. via text message, email, instant message, microblog post, push notification via the image acquisition application in the user's respective mobile devices, etc.). The matching users can then either accept or deny the request. In step 108, the images can be received from the matching users that accepted the request. In step 110, the image can be made available to the requesting user. For example, the requesting user can be provided a hyperlink to the image in a web server. The image can be communicated to the requesting user's mobile device (e.g. via text message, email, instant message, microblog post, push notification via the image acquisition application in the user's respective mobile devices, etc.). In some embodiments the users can also provide images proactively, and the system can store (with time and location stamp) for later use, and/or stream to devices set to receive random or context based images (e.g. a billboard displaying live sun rises around the globe while providing ad for a vacation getaway).

In some embodiments of process 100, the image acquisition system can provide compensation (e.g. pecuniary compensation) to users who obtain images for the image acquisition system. In some embodiments, a requesting user can pay a fee and/or request for bids to obtain an image from the image acquisition system. The image acquisition system can be configured to manage pecuniary transactions between users and/or manage a bidding process.

In some embodiments of process 100, the image acquisition system can integrate images with at least one common context attribute (e.g. a common location) into a single presentation (e.g. a slide show, combine various images of a building into a single unified image, etc.). Various visual effects (e.g. 3D modelling of the images, etc.) can be implemented with images with at least one common attribute. 3D interactive view can also be created from a single image with depth information. In some use cases the image/video/audio is auto corrected (cropped, enhanced, noise reduction, shake stabilization, selected focusing, etc.) by the system to provide better information and/or user experience.

In some embodiments of process 100, the image acquisition system can be configured to enable a requesting user to provide real-time feedback to the user obtaining the image. For example, the requesting user can receive a requested image and then provide additional instructions for a next image (e.g. instructions to modify perspective, digital camera parameters/settings, etc.). The image acquisition system can be configured to enable the requesting user to modify the remote digital camera parameter/settings of the user obtaining the image as well (e.g. via a client application in the remote digital camera). In this way, the requesting user can control aspects of a digital image acquisition process without the need of intervention by the user obtaining the image. The image acquisition system can implement video feeds between the two user's mobile devices and allow the requesting user to control various settings of either mobile device that modify the attributes of the digital images of the video feed (e.g. modify the settings of the digital camera in the remote mobile device obtaining the video feed using an application in the requesting user's mobile device). In some embodiments of process 100, the image acquisition system can provide thumbnail views of available digital images and/or video feeds of a particular event (e.g. as obtained by multiple users) to a requesting user. The requesting user can then select a particular thumbnail for viewing, purchase, integration into a 3-D model, etc. In some embodiments of process 100, the image acquisition system can be configured to enable a requesting user to submit a particular image of an object and/or set of images of the object to a 3-D printing service. The 3-D printing service can then generate a 3-D physical model of the object in the requested image. If the 3-D printing service requires another image of the object, the 3-D printing service can request the image with specified required context attributes (e.g. “need a picture of the back of the sculpture's head”) to the image acquisition system. The image acquisition system can then automatically determine a user in the vicinity of the object to instruct to obtain the image based on the parameters provided by the 3-D printing service. The requesting user can instruct and control multiple devices/users at the other end.

In some embodiments of process 100, the image acquisition system can be configured to monitor the digital cameras of a set of users. The image acquisition system can determine when a particular digital camera is in an optimal setting (e.g. location, perspective, lighting, orientation of the mobile device, time, view of an object, etc.) and automatically instruct the digital camera to obtain an image. In this way, a requesting user can upload a particular set of context attributes with respect to an object and then wait for the image acquisition system to detect that another user's digital camera (e.g. an outward facing digital camera in head-mounted display) to satisfy said context attributes. The image acquisition system can be configured to enable a requesting user to ‘eaves drop’ on various other user's outward facing camera's view and select which remote devices to obtain images. In some embodiments of process 100, the image acquisition system can be configured to provide acquired digital images in real time to digital billboards, video channels, etc. The digital billboards integrate the real time images into the advertisement content. Additionally, portions of video documentaries can be configured to include real-time images that match specified context attributes provided by the documentarian. In some embodiments of process 100, the image acquisition system can be configured to automatically obtain all the digital images acquired by a specified mobile device and then filter said images based on previous requests for images. The selected images can then be automatically provided to the respective requesting users. The image acquisition system can be configured to automatically recognize the text and convert it using optical character recognition (OCR) technology. The image acquisition system can be configured to perform certain functions with the text, such as saving information on a business card to a new contact entry, translating text from a language into another language (e.g. English), searching on-line for products depicted in the image and/or text, etc. Process 100 can include steps that enable both the sender and/or receiver to modify the image. For example, image editing software can be made available to enable a user to manipulate visual images on a computer. Manipulations can include integrating augmented-reality elements, animation elements, three-dimensional elements and the like, into the digital image.

In some examples, process 100 can be modified to acquire goods and/or services instead of and/or in addition to digital images. For example, a user may want a specific good from a particular location. The image acquisition system can be configured to accept requests for the specifled good from the particular location, determine another user to obtain the specified good. The obtaining user can then send the specific good to the requesting user and/or an intervening party. The system can figure out the shipping method and rout (based on travel plans, willingness, etc.)

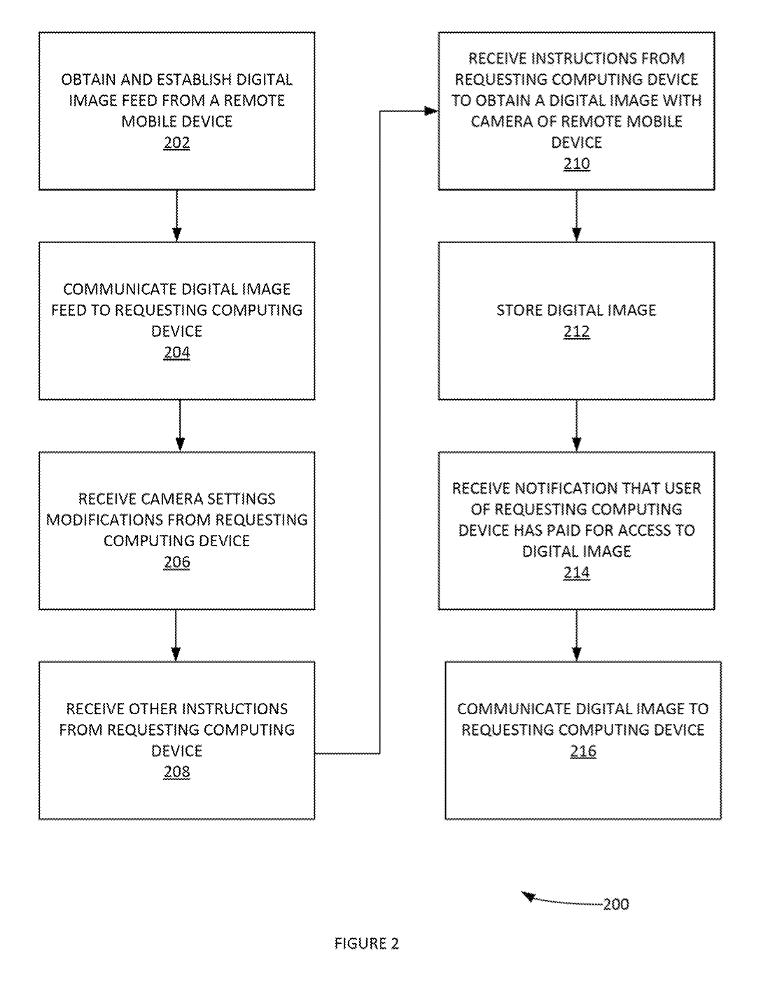

FIG. 2 illustrates an example process 200 of e-commerce of remote digital image and/or model acquisition according to some embodiments. As used herein, e-commerce can include trading in products or services using computer networks, such as the Internet. Electronic commerce draws on technologies such as mobile commerce, electronic funds transfer, supply chain management, Internet marketing, online transaction processing, electronic data interchange (EDI), inventory management systems, and/or automated data collection systems.

In step 202 of process 200, a digital image feed from a remote mobile device can be obtained and/or established. For example, a cloud-computing entity can manage the client-applications in the remote mobile device and a computing device implementing process 200. The client applications can access a digital camera of the remote mobile device and the display applications of the computing device. The client applications can communicate the digital feed information to the cloud-computing entity via a computer network. The client application can also receive from the cloud-computing entity and then display the digital feed in step 204. It is further noted that the client applications can include a user interface for specifying parameters for requesting a remote digital feed (e.g. specifying location, mobile device type, user photography experience, description of location, monetary compensation terms, and/or image to be photographed/modelled, etc.). The cloud-computing entity can maintain a list of remote users that may be available to obtain the digital feed.

In one example, the cloud-computing entity can contact qualifying users and negotiate the terms for obtaining the feed. In another example, the cloud-computing entity can provide a communication mechanism between the requesting user and the remote user such that the two or more users can directly negotiate the terms. The terms can then be stored in a datastore managed by the cloud-computing entity. The cloud-computing entity can enforce said terms should a dispute later arise. In one example, the terms can stipulate a pay-per-image contract term. In another example, the term can include a pay-per-second (or other time period) term. The cloud-computing entity can manage dispersal and/or collection of payments.

In step 206, camera settings of the remote mobile device can be obtained and communicated to the requesting computing device. Example digital camera settings can include aperture, shutter speed, white balance, color settings, focus, flash modes, depth of field, lens selection, virtual lens selection (e.g. fisheye, etc.), panoramic mode, frame size, ISO, other exposure settings, etc. Available digital camera settings can be obtained by the remote camera client application from the remote mobile device's operating system. The cloud-computing entity can obtain the settings and communicate them to the requesting computing device.

In step 208, other instructions can be received from the requesting computing device. For example, a request to take multiple perspectives images and/or videos of an object. The location of the remote user of the remote mobile device can be provided. For example, an communication feed (e.g. videotelephony, telephone, conference call, text message, instant message application, etc.) can be established between the remote mobile device and the requesting computing device by the cloud-computing entity or other entity (e.g. a telephony service). In this way, the requesting user can view the video feed and provide explicit location and perspective requests (e.g. ‘move back a few meters’, ‘hold the camera a little higher’, ‘go to the other side of the building’, etc.). In the case of a video feed, motion instructions can be provided to the remote user. Visual cues can be displayed on the remote mobile device screen to cue the remote user with respect to the location and/or perspective of the remote mobile device. In some examples, the cloud-based entity can provide a translation service.

Accordingly, in step 210, instructions can be received to obtain the digital image from remote mobile device. For example, a requesting user can hit a virtual button on the client-application that indicates the user would like the digital image to be obtained. The remote user may not be aware that the digital image is being obtained.

In step 212, the digital image can be stored in a database managed by the cloud-computing entity. The cloud-computing entity may not provide the digital image to the requesting user until the agreed upon fee has been provided. In some examples, the requesting user can accesses a lower quality and/or smaller version (e.g. a thumbnail, etc.) of the digital image until the the payment is verified.

In step 214, notification that the requesting user has made the payment can be received. At this time, the digital image (or higher quality/size version) can be released to the requesting user. For example, the digital image can be emailed and/or otherwise communicated to the requesting user in step 216 (e.g. sent to the requesting computing device's client application via a computer/cellular network, etc.). The requesting user can be provided access to ta file hosting service that stores the digital image. It is noted that digital videos and/or 3D printing digital models can be in additional to digital images in some embodiments.

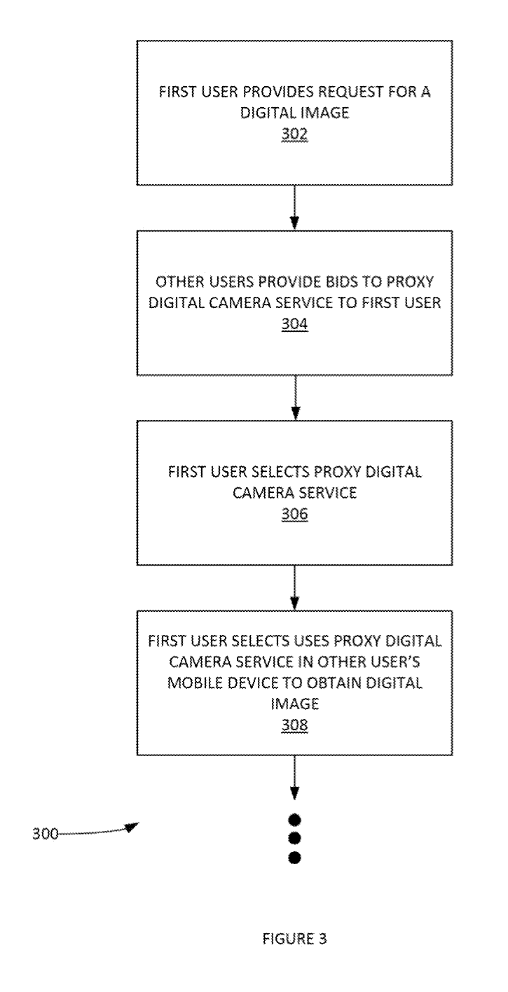

FIG. 3 illustrates another example process 300 of e-commerce of remote digital image and/or model acquisition according to some embodiments, according to some embodiments. More specifically, process 300 illustrates an example of multiple bids from proxy digital-camera services. In step 302, a first user (e.g. the requesting user of process 200, a 3D marketplace, etc.) can provide a request for a digital image. In step 304, other users (e.g. users of remote mobile devices and the like) can provide bids to the proxy digital-camera service to service the request by the first user. In step 306, the first user can select a proxy digital-camera service. For example, the first user can select the proxy digital-camera service with the lowest bid, the best ratings by other users, etc. In step 308, the first user can then utilize the proxy digital-camera service via another user's mobile device to obtain a digital image. For example, step 308 can include process 100 and/or 200 or portions thereof.

Exemplary Computer Architecture and Systems

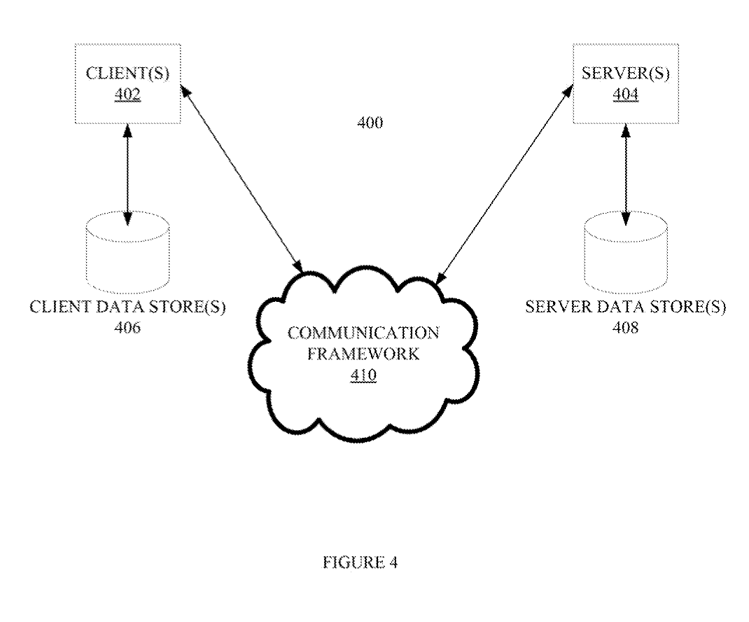

FIG. 4 is a block diagram of a sample computing environment 400 that can be utilized to implement various embodiments. The system 400 further illustrates a system that includes one or more client(s) 402. The client(s) 402 can be hardware and/or software (e.g., threads, processes, computing devices). The system 400 also includes one or more server(s) 404. The server(s) 404 can also be hardware and/or software (e.g., threads, processes, computing devices). One possible communication between a client 402 and a server 404 may be in the form of a data packet adapted to be transmitted between two or more computer processes. The system 400 includes a communication framework 410 that can be employed to facilitate communications between the client(s) 402 and the server(s) 404. The client(s) 402 are connected to one or more client data store(s) 406 that can be employed to store information local to the client(s) 402. Similarly, the server(s) 404 are connected to one or more server data store(s) 408 that can be employed to store information local to the server(s) 404. In some embodiments, system 400 can instead be a collection of remote computing services constituting a cloud-computing platform.

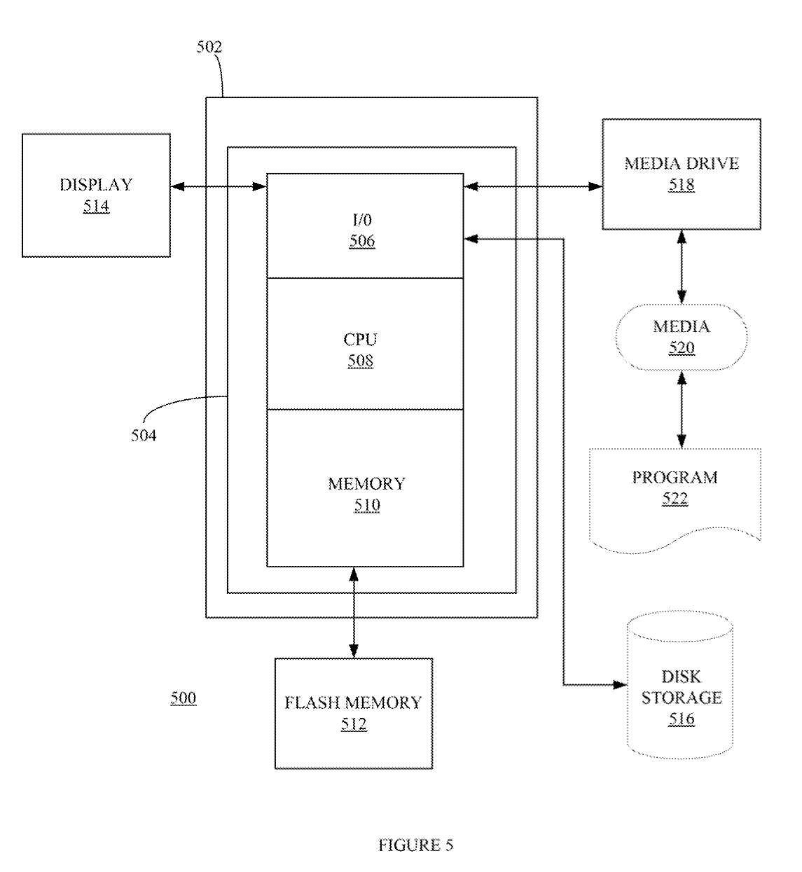

FIG. 5 depicts an exemplary computing system 500 that can be configured to perform any one of the processes provided herein. In this context, computing system 500 may include, for example, a processor, memory, storage, and I/O devices (e.g., monitor, keyboard, disk drive, Internet connection, etc.). However, computing system 500 may include circuitry or other specialized hardware for carrying out some or all aspects of the processes. In some operational settings, computing system 500 may be configured as a system that includes one or more units, each of which is configured to carry out some aspects of the processes either in software, hardware, or some combination thereof.

FIG. 5 depicts computing system 500 with a number of components that may be used to perform any of the processes described herein. The main system 502 includes a motherboard 504 having an I/O section 506, one or more central processing units (CPU) 508, and a memory section 510, which may have a flash memory card 512 related to it. The I/O section 506 can be connected to a display 514, a keyboard and/or other user input (not shown), a disk storage unit 516, and a media drive unit 518. The media drive unit 518 can read/write a computer-readable medium 520, which can contain programs 522 and/or data. Computing system 500 can include a web browser. Moreover, it is noted that computing system 500 can be configured to include additional systems in order to fulfill various functionalities. Computing system 500 can communicate with other computing devices based on various computer communication protocols such a Wi-Fi, Bluetooth® (and/or other standards for exchanging data over short distances includes those using short-wavelength radio transmissions), USB, Ethernet, cellular, an ultrasonic local area communication protocol, etc.

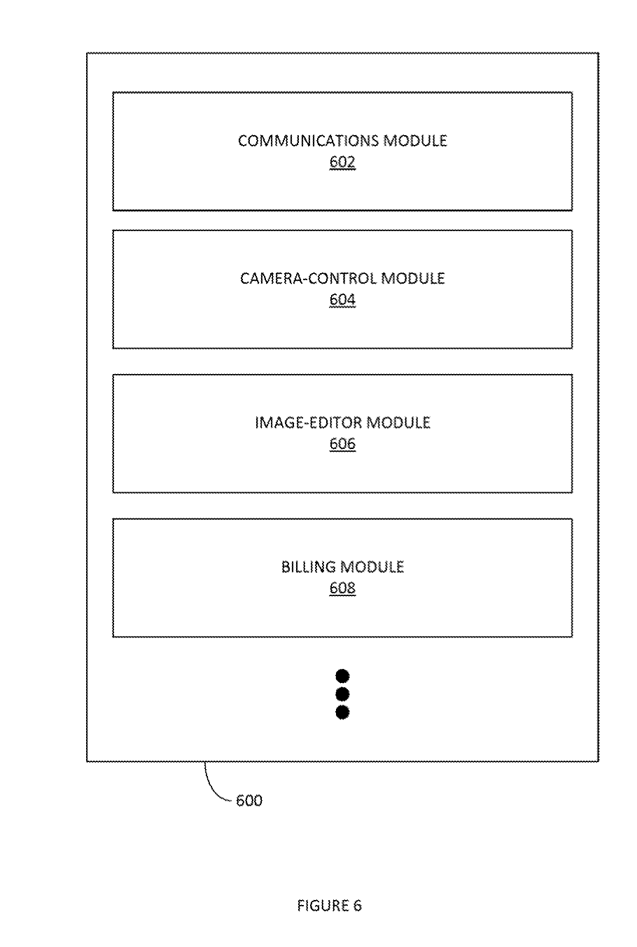

FIG. 6 depicts, in block diagram format, an example remote third-party digital acquisition service server entity 600, according to some embodiments. Third-party digital acquisition service server entity 600 can be implemented as a system that responds to requests across a computer network to provide, or help to provide, a network service. Third-party digital acquisition service server entity 600 can be implemented as a cloud-computing entity (e.g. the cloud-computing entity that implements portions of process 200). Third-party digital acquisition service server entity 600 can implement the server-side functionalities of processes 100, 200 and/or 300. Third-party digital acquisition service server entity 600 can include manage a proxy digital-camera service.

More specifically, third-party digital acquisition service server entity 600 can include a communications module 602. Communications module 602 include various communications servers such as an e-mail server, text-messaging server, telephony servers, video telephone servers, etc. Communications module 602 can transfer computer files from one host to another host over a TCP-based network, such as the Internet. Communications module 602 can establish video feeds between a digital camera in a remote mobile device and a requesting computer. Communications module 602 can generate various messages and push said messages to applications. Accordingly, communications module 602 can perform the various communications functions provided in processes 100, 200, and/or 300.

Camera-control module 604 can control the settings and/or operation of remote digital cameras in remote mobile devices. For example, camera-control module 604 can communicate instructions to a client-side application in a mobile device. The client-side application can have permission to control the digital camera system. Camera-control module 604 can receive information from remote digital cameras as well. Example information includes, inter alia: current camera settings, available camera parameters and/or settings, digital images, video fees, etc. Camera-control module 604 can also control and/or access a mobile device's microphone system in some embodiments.

Image-editor module 606 can used to edit/modify remotely obtained images. Image-editor module 606 can include a graphics editor program (e.g. a raster graphics editor, a vector graphics editor, etc.). In some examples, a user can provide automatic graphics edit preferences. In other examples, a user can access a digital image and manually edit said digital image. Image-editor module 606 can provide quality control measures on received digital images in some examples. For example, image-editor module 606 can resize received digital images and/or others upgrade said digital images according to parameters set by a system administrator.

Billing module 608 can manage the various monetary transactions of third-party digital acquisition service server entity 600. Billing module 608 can also manage the various bidding operations discussed supra.

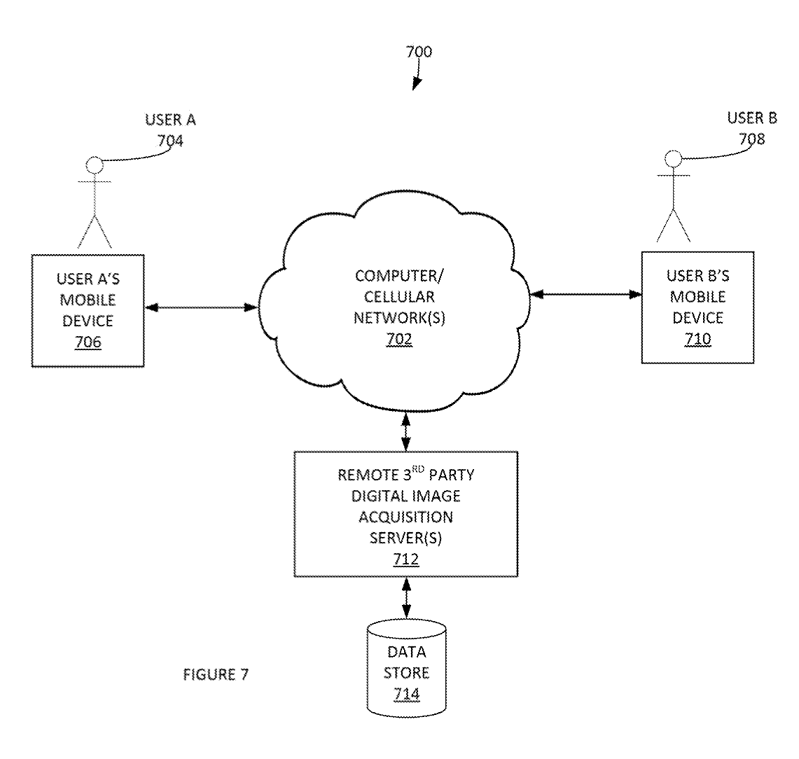

FIG. 7 depicts, in block diagram format, an example system 700 for implementing a third-party digital acquisition service, according to some embodiments. System 700 can include computer/cellular networks 702 (e.g. the Internet, a digital cellular network, etc.). System 700 can include user A 704 (e.g. a requesting user) and user A's mobile device 706. User A 704 can use an application in mobile device 706 to request a digital image from the digital camera in user B's mobile device 710. User A 704 can use the application in mobile device 706 to control the settings of digital image from the digital camera in user B's mobile device 710. User A 704 can use the application in mobile device 706 to communicate with user B 708. User B 708 can position mobile device 706 according to the instructions of user A 704. Remote third-party digital acquisition service server entity 712 can include functionalities to implement this process as well as those provided in remote third-party digital acquisition service server entity 600. Information used and/or obtained by system 700 can be stored in data store 714. Remote third-party digital acquisition service server entity 712 can generate models for three-dimensional printers from digital images and/or other information (e.g. positional information, accelerometers, etc.) from mobile device 706.

Any images acquired can be given an automated file-name and other file properties for easier retrieval or identification (at a later time). For example a sunset image at Niagara Falls can bear the automated image name ‘sunset-at-niagara-falls-on-dd-mm-yyyy.jpg’. The user can also speak the file name and/or other characteristics that are automatically applied to the image file. The system (e.g. system 600 and/or 700 supra and/or process 100) can also display a list of most sought for image requests that are unfulfilled so that any image-providing users can prioritize their offering appropriately. The system can generate/synthesize images/videos based on the request text in the event the exact image/video does not already exist. For example, a user can request ‘me running in Himalayas’, the user can receive an image (e.g. can include a video) of the Himalayas with the user's image superimposed to provide a realistic look that the user is running in Himalayas. In general, the system can include various digital image and/or video editor functionalities to automatically synthesize an image/video given a script.

The system can also notify a group of users to coordinate and accomplish a task. For example if a user would like a video of someone running in a park, then multiple users can be identified in a park or the desired park. One of the multiple users may be willing to take the shoot of another running. Another user can be arranged to shoot another video from a different angle.

The system also can enable voluntary images submission from users. For example, if a user is at an interesting/meaningful/special event, the user can just obtain images and submit them to the system. Each image is stamped with identifying metadata, such as: time, location, and/or other useful attributes. At a later time, if any interested party requests for specific image, the system can provide such images or footages. The system can provide popular channels/web links that can stream images automatically. For example, pointing a web browser to “www.company.com/image/stream?type=sunset” (or any other static or dynamic links), can provide streaming for ‘sunset(s)’ around the world.

In another use case, the images can be displayed as screen savers or other time fillers (e.g. in an event when people are waiting for the event to begin, the screen can display/stream some appropriate previously saved or live images). In another example, a speaker or presenter can incorporate any previously stored or live images in a speech and/or presentation. Incorporating the images can also be automatically implemented to give a more authentic and lively experience. For example, the speaker can provide keywords or some text or context, and the system can automatically pull relevant images from the system's data store (e.g. from live request and/or from saved images) to be incorporated on the spot. As an example, if there is a talk ‘natural disasters’, the system can provide appropriate images based on the context which the speaker can directly incorporate in the talk live on the spot.

The system can also automatically verify the authenticity of a specific event. For example, if two or more independent and/or unrelated users can provide similar images of an event, the event state can be set as ‘true’. The system can recognize similar images. The images could also be verified by a human (and/or a combination of both human and a machine vision). News agencies can use this feature to verify the authenticity of an event as they report the news and receive images from the public.

Various map integration methods can be implemented. For example, a user can click on a map to request image from that area or surrounding area. Clicking on a map can automatically displays any scenic area (e.g. a waterfall), event going on (e.g. a football game), or some developing event (e.g. a marathon), etc. A user can select a region (e.g. rectangular region, circular region, etc.). Specified types of interesting places/events in the selected area can be displayed (e.g. in a drop down list that the user can select where to request the image). The selection list can be personalized based on the user. For example, if a user is a nature lover, the nature-oriented locations/items can be presented in the list before a sports event. The system can be used for image synthesis as a function of time and space. For example, a graphical view of around the world at a specific time, how a place has changed over time, or events taking place as a function of time-and-path. This can be integrated with the map selection concept, where the user can specify a path in the map. Automatically generating a photo album/movie/documentary/demo/etc. from the images.

In some embodiments, the system's ability to determine the location, time, and any other parameters automatically based on the user's request and information available in the World Wide Web. For example, if a user requests an image of a developing event somewhere without providing any location or time information explicitly, the system can determine or search for the missing information in the World Wide Web and process the request accordingly. In case of ambiguity, the system can ask the requesting user for clarification (e.g. via text message using a set of pre-written requests or ad hoc generated requests). Accordingly, the system can include a natural language generator. In one example, a user can request a ‘sunset’ image. The system can automatically determine an appropriate time of the sunset (e.g. based on an almanac website). If user requested ‘World Cup’ image, the system can search the World Wide Web to determine where and when the next event is going to take place. Appropriate requests can then be communicated to users at appropriate locations and times.

### CONCLUSION

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it can be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

What is claimed as new and desired to be protected by Letters Patent of the United States is:

1. A method comprising:
receiving a digital-image request, wherein the digital-image request comprises a digital-image content instruction and a digital-image content location instruction, and wherein the digital-image request is generated by a first user;
determining a digital camera of a second user at a location designated in the digital-image content location instruction, and wherein the digital camera is integrated into a second user's mobile device;
communicating the digital-image request to the second user's mobile device;
receiving a digital image from the second user's mobile device; and
communicating the digital mage to a first user's computing device.

2. The method of claim 1, wherein the digital image comprises a digital video file.

3. The method of claim 1, wherein the digital-image content instruction comprises a time of day to obtain the digital image.

4. The method of claim 1, wherein the digital-image content instruction comprises a visual angle of the digital camera when the digital camera obtains the digital image.

5. The method of claim 1, wherein the mobile device comprises a smart phone.

6. The method of claim 1 further comprising:
accessing a digital camera control system in an operating system of the the second user's mobile device;
downloading an information about at least one setting of the digital camera control system; and
communicating the information about at least one setting of the digital camera control system to the first user's first user's computing device.

7. The method of claim 6 further comprising:
receiving an instruction to modify the at least one setting of the digital camera control system from the first user's first user's computing device; and
communicating the instruction to modify the at least one setting of the digital camera control system to the second user's mobile device.

8. The method of claim 7, wherein a setting of the digital camera control system comprises a color setting of the digital camera.

9. The method of claim 8, wherein the information about at least one setting of the digital camera control system comprises a digital-camera image feed from digital camera.

10. The method of claim 9 further comprising:
displaying the digital-camera image feed on the first user's computing system.

11. A computerized system comprising:
a processor configured to execute instructions;
a memory containing instructions when executed on the processor, causes the processor to perform operations that:
receive a digital-image request, wherein the digital-image request comprises a digital-image content instruction and a digital-image content location instruction, and wherein the digital-image request is generated by a first user;
determine a digital camera of a second user at a location designated in the digital-image content location instruction, and wherein the digital camera is integrated into a second user's mobile device;
communicate the digital-image request to the second user's mobile device;
receiving a digital image from the second user's mobile device; and
communicate the digital mage to a first, user's computing device.

12. The computerized system of claim 11, wherein the digital image comprises a specified object to include in the digital image.

13. The computerized system of claim 11, wherein the digital-image content instruction comprises a plurality of views of the specified object to include in the digital image.

14. The computerized system of claim 11, wherein the memory containing instructions when executed on the processor, further causes the processor to perform operations that:
access a digital camera control system in an operating system of the second user's mobile device;
download an information about at least one setting of the digital camera control system; and
communicate the information about at least one setting of the digital camera control system to the first user's first user's computing device.

15. The computerized system of claim 14 wherein the memory containing instructions when executed on the processor, further causes the processor to perform operations that:
receive an instruction to modify the at least one setting of the digital camera control system from the first user's first user's computing device; and
communicate the instruction to modify the at least one setting of the digital camera control system to the second user's mobile device.

16. The computerized system of claim 15, wherein a setting of the digital camera control system comprises an aperture setting of the digital camera.

17. A method comprising:
receiving a digital-image request, wherein the digital-image request comprises a digital-image content instruction and a digital-image content location instruction, and wherein the digital-image request is generated by a first user;
determining a set of digital cameras of a plurality of other users at a location designated in the digital-image content location instruction, and wherein the set of digital cameras are integrated into a plurality of other users' mobile devices;
communicating the digital-image request to the plurality of other users' mobile devices;
receiving a set of digital images from one or more of the plurality of other users' mobile devices; and
communicating the set of digital images to a first user's computing device.

18. The method of claim 17, wherein each of the plurality of other users are assigned a separate angle from which to obtain a digital image.

19. The method of claim 18 further comprising:
accessing a digital camera control system in each operating system of the plurality of other users' mobile devices; and
downloading an information about at least one setting of each digital camera control system of the plurality of other users' mobile devices.

20. The method of claim 19 further comprising:
communicating the information about at least one setting of each digital camera control system to the first user's computing device;
receiving an instruction to modify a setting of at least one of the digital camera control systems from the first user's computing device; and
communicating the instruction to modify the setting of the digital camera control system to an appropriate mobile device of the plurality of other users' mobile devices.
